(19) United States
(12) Patent Application Publication
(10) Pub. No.: US 2007/0039796 A1
(43) Pub. Date: Feb. 22, 2007

(54) Clutch device

(75) Inventors: Arthur Schroder, Dittelbrunn (DE); Rudiger Lotze, Schweinfurt (DE); Jorg Sudau, Niederwerrn (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/506,713

(22) Filed: Aug. 18, 2006

(30) Foreign Application Priority Data
Aug. 19, 2005 (DE) 10 2005 039 272.5

(51) Int. Cl. F16D 25/06

(52) U.S. Cl. 192/85 AA

(57) ABSTRACT

A clutch device has a housing connected to a drive; a takeoff, which is mounted with freedom of rotation in the circumferential direction relative to the housing; and at least one friction clutch, which is mounted in the housing and which can be shifted between an engaged position and a released position. The clutch has clutch components including at least one pressure-exerting device and at least one clutch element which can be actuated by the pressure-exerting device, both the clutch element and the pressure-exerting device being able to shift position to a limited extent in the axial direction. The clutch element has at least one friction surface and a clutch hub in working connection with the takeoff. Beginning at a point of contact between the engaged position and the released position and continuing until the engaged position is reached, the torque of the drive can be transmitted via the housing and the friction clutch to the takeoff, whereas on the other side of the contact point and continuing until the released position, this torque transmission is suspended. A torque-building arrangement, which exerts force on the pressure-exerting device in the direction pointing away from the clutch element of the friction clutch, is assigned to the pressure-exerting device. This torque-building arrangement uses the pressure-exerting device as a first support element on one side and the clutch element as a second support element on the other side. On at least one of these support elements and/or on the torque-building arrangement, at least one flow passage is provided for the fluid which is present in a cooling space inside the housing in which the friction clutch is disposed.

### BACKGROUND OF THE INVENTION

1. Field of the Invention

The invention relates to a clutch device having a housing connected to a drive and a takeoff, mounted with freedom of rotation in the circumferential direction relative to the housing.

At least one friction clutch is disposed within the housing and can be shifted between an engaged position and a disengaged or released position, and which has, as clutch components, at least one pressure-exerting device and at least one clutch element which can be actuated by the pressure-exerting device. The clutch element, like the pressure-exerting device, is free to shift its position to a limited extent in the axial direction and has at least one friction surface and a clutch hub in working connection with the takeoff, and wherein, beginning at a contact point between the engaged position and the released position and continuing until the engaged position is reached, the torque of the drive can be transmitted via the housing and the friction clutch to the takeoff, whereas, on the other side of the contact point and continuing until the released position, this torque transmission is suspended

2. Background of the Invention

A clutch device of this type is known from DE 102 34 822 A1. In an embodiment shown in this publication, the pressure-exerting device is formed by a piston, which acts on a friction clutch, formed by a plurality of clutch elements in the form of plates. For cooling, the clutch elements are arranged in a cooling space, which is connected via a feed line and a discharge line to an external source of pressurized fluid and is separated by the piston from a pressure space, which is much smaller in terms of both volume and radial dimension. The pressure space can be pressurized via a control line, which is provided in the takeoff, which is designed as a gearbox input shaft. When the pressure in the pressure space is positive versus the pressure in the cooling space, the piston is pushed toward the latter and thus engages the friction clutch, whereas, after the pressure in the pressure space has been reduced via the control line to a point below the pressure level in the cooling space, the piston moves in the opposite direction and thus the friction clutch is released.

In clutch devices of this type, there is a problem between the contact point and the engaged position, namely, that the nonelastic piston arrives in working connection with friction surfaces of the friction clutch, which are also nonelastic, and accordingly a very short engagement distance is available for the buildup of torque transmission, called “modulation”. As a result, the engagement process is relatively hard and subject to jolts. In addition, radial and/or axial tolerances between the clutch elements as well as a possible waviness of the friction surfaces in the circumferential direction can have disadvantageous effects on the degree of utilization of the friction surfaces in their current state for the transmission of torque. These effects becoming manifest as an increase in the applied surface pressures in certain areas.

### SUMMARY OF THE INVENTION

One object of the present invention is to design a clutch device in such a way that, while avoiding thermal problems with the clutch elements of the friction clutch, the disadvantageous effects of tolerances and waviness are excluded, while at the same time the clutch engages softly and uniformly.

When a torque-building or generating arrangement is associated with the pressure-exerting device, the modulation, that is the governing and/or control of the clutch-engaging process and thus the buildup of the transmission of torque between the contact point and the engaged position, will proceed with particular uniformity and softness, especially when the torque-building arrangement is designed with an axial force storage device serving as a contact spring, as a result of which additional elasticity is introduced between the pressure-exerting device and the minimum of one clutch element of the friction clutch. As a result, it is ensured that the individual contact surfaces of the clutch elements, such as the pressure-exerting device and the clutch element or several clutch elements, will make better adaptive contact with each other. Thus not only axial and/or radial tolerances between the individual clutch elements, but also any waviness which may be present in the area of the friction linings or friction surfaces of the clutch elements, can be compensated more effectively.

Because the torque-building arrangement uses the pressure-exerting device as a first support element and uses the clutch element as a second support element, it cannot be excluded that certain areas are created, namely, a first area between the pressure-exerting device and the torque-building arrangement and a second area between the latter and the clutch element, in which the torque-building arrangement generates a sealing effect and thus at least considerably reduces the flow-through of the fluid which is present in the cooling space which houses the friction clutch. Because both the pressure-exerting device and the clutch element are clutch components of the friction clutch, and because these components undergo heating, especially when there is slippage between a drive, such as the crankshaft of an internal combustion engine, and a takeoff, such as a gearbox input shaft, it is necessary to prevent this heat from leading to unwanted thermal stresses on the pressure-exerting device, on the fluid, and/or on the adjacent clutch disk. For this reason, a flow passage for fluid is provided in at least one of the support elements, i.e., on the pressure-exerting device and/or on the clutch element, through which, as a result of the relative rotational movement of the clutch elements with respect to each other, fluid is supplied to support the flow and thus to dissipate the heat from the support element in question.

In one embodiment, the flow passage can be designed in the form of grooves in the pressure-exerting device and/or in the adjacent clutch element, but it could just as well be in the form of openings between offset tongues on the circumference of the torque-building arrangement. The latter embodiment is especially advantageous when the torque-building arrangement has an axial force storage device, formed by a disk spring, which, proceeding from an essentially ring-shaped base body, carries the previously mentioned tongues on its inner and/or outer radial side.

When the torque-building arrangement includes a disk spring, the formation of a flow channel in at least one of the support elements is especially advantageous, because the disk spring is dosed on its radial sides and thus can be made thinner in cross section than a disk spring with tongues on at least one radial side. As a result, a space advantage is obtained, namely, in the comparatively narrow axial area between the pressure-exerting device and the adjacent clutch element.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

Exemplary embodiments of the invention are explained in greater detail in the following on the basis of the drawing(s) in which:

FIG. 1 is a schematic view of the upper half of a longitudinal cross section through a clutch device of the present invention including a torque-building arrangement with an axial force storage device located between a pressure-exerting device and a clutch element;

FIG. 2 shows an enlarged cross-sectional view of the detail circled and marked with an “X” in FIG. 1, with a flow passage in the pressure-exerting device;

FIG. 3 shows a view of the pressure-exerting device viewed in direction A of FIG. 2;

FIG. 4 is similar to FIG. 2, except that it shows a cross-sectional view of a flow passage in the clutch element adjacent to the pressure-exerting device;

FIG. 5 shows a plan view of the clutch element looking in direction B of FIG. 4;

FIG. 6 is similar to FIG. 2, except that it shows a cross-sectional view of a flow channel in the axial force storage device of the torque-building arrangement; and

FIG. 7 shows a plan view of the torque-building arrangement looking in direction C of FIG. 6.

### DETAILED DESCRIPTION OF THE PRESENTLY PREFERRED EMBODIMENTS

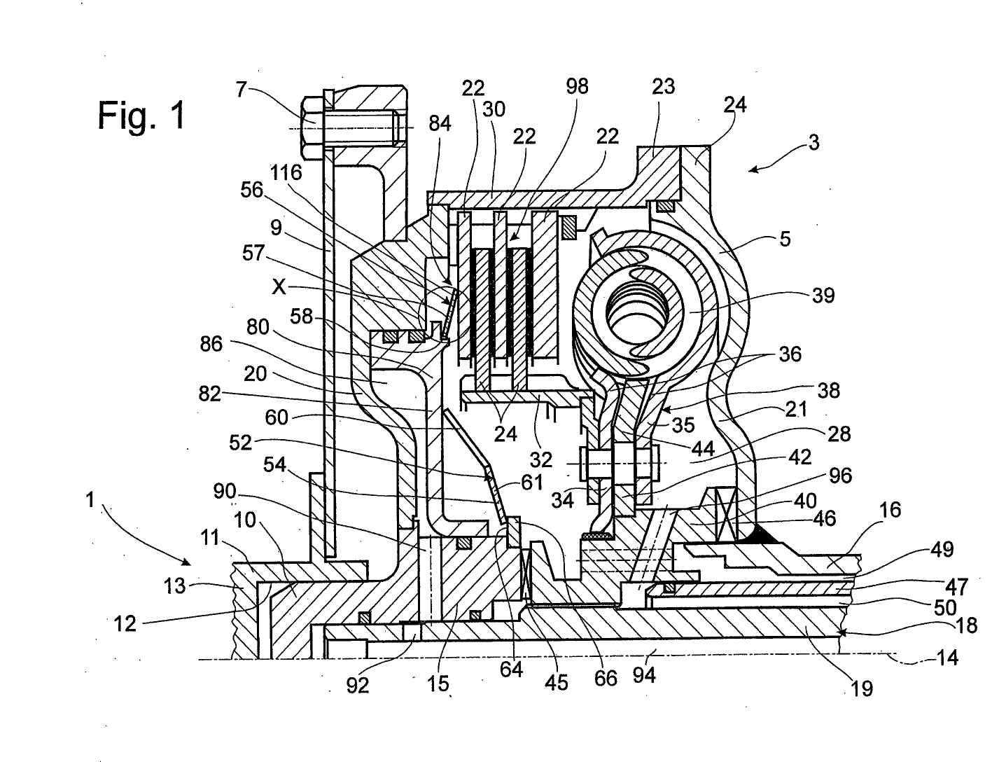

FIG. 1 shows a schematic diagram of a drive train 1 with a clutch device 3 of the present invention. The clutch device 3 comprises a housing 5, which can be connected for rotation together with a drive 11, such as the crankshaft 13 of an internal combustion engine, by means of a plurality of mounting elements 7 and a connecting element 9 such as a flexplate. In the area of an axis of rotation 14, the clutch device has a bearing journal 10 provided on a drive-side housing hub 15. The journal is mounted in a centering guide 12 formed on the drive 11. On the axial side facing away from the drive 11, the housing 5 has a takeoff-side housing hub 16, which is connected to, for example, a gearbox arrangement (not shown) and rotatably drives there a fluid-conveying pump (also not shown). A takeoff 18, the free end of which projects from the housing 5, is mounted concentrically with respect to the takeoff-side housing hub 16. This takeoff 18 can be formed by, for example, a gearbox input shaft 19.

The housing 5 has a drive-side housing wall 20, which extends from the drive-side housing hub 15 essentially in the radially outward direction, and a takeoff-side housing wall 21, which extends from the takeoff-side housing hub 16 in an essentially radially outward direction. In their respective radially outer areas, the two housing walls 20, 21 merge with housing outer shells 23, 24, which connect the two housing walls 20, 21 axially together and are fastened to each other in a pressure-tight manner by appropriate means (not shown) to prevent the loss of fluid from a cooling space 28, which is enclosed by the housing walls 20, 21 and the housing outer shells 23, 24.

Disposed in the cooling space 28 of the housing 5, is a plurality of first clutch elements 22, which are connected for rotation together with the housing 5 and thus to its housing outer shell 23, acting as the drive-side clutch element carrier 30, and a plurality of second clutch elements 24, which are mounted nonrotatably on a takeoff-side clutch element carrier 32, to form a friction clutch 98. The takeoff-side clutch element carrier 32 is supported radially by way of a first cover plate 34 of a torsional vibration damper 38 on a clutch hub 40 of the torsional vibration damper 38, where the first cover plate 34 cooperates with a second cover plate 35 to form the input section 36 of the torsional vibration damper 38. The input section 36 is able to rotate against the action of the energy storage devices 39 relative to an output section 42 in the form of a hub disk 44, the hub disk 44 being fastened nonrotatably to the clutch hub 40. The clutch hub 40 for its own part is centered both on the takeoff-side housing hub 16 and on a support shaft 47, mounted radially between the housing hub 16 and the takeoff 18, and is connected for rotation in common with the takeoff 18. The support shaft 47 and the takeoff-side housing hub 16 together define a first ring-shaped channel 49, whereas the support shaft and the takeoff 18 together form a second ring-shaped channel 50.

The clutch hub 40 is positioned with respect to the drive-side housing hub 15 by a first axial bearing 45 and with respect to the takeoff-side housing hub 16 by a second axial bearing 46.

The drive-side housing hub 15 holds a pressure-exerting device 80 axially between the drive-side housing wall 20 and the clutch hub 40. The pressure-exerting device 80 is formed as a piston 82 and can be brought into working connection with the adjacent clutch element 22 by way of a torque-building or torque generating arrangement 56 in the form of an axial force storage device 57. The torque-building arrangement 56 is supported on one side against a circumferential bead 58 of the pressure-exerting device 80 and on the other side against the facing side of the adjacent clutch element 22.

The pressure-exerting device 80, like each of the clutch elements 22, 24, acts as a clutch component 84 of the friction clutch 98. A clutch-release support arrangement 52 in the form of an axial force storage device 54 is provided radially inside the clutch elements 22, 24 and rests against the pressure-exerting device 80. The other side of this clutch-release support arrangement 52 rests against a support surface 64 of a component 66 in the form of a radial projection, fixedly mounted on the drive-side housing hub 15. The clutch-release support arrangement 52 acts on the pressure-exerting device 80 so as to push the pressure-exerting device 80 toward the drive-side housing wall 20.

The pressure-exerting device 80 is mounted axially between the drive-side housing wall 20 and the cooling space 28 and cooperates with the drive-side housing wall 20 to form the boundary of a pressure space 86, which is connected to a central bore in the gearbox input shaft 19, serving as a control line 94, by means of flow passages 90 in the drive-side housing hub 15 and via flow passages 92 in the takeoff 18, i.e., in the gearbox input shaft 19. In addition, flow channels 96 are provided in the clutch hub 40, through which a flow connection can be established between the channel 50 and the cooling space 28. Cooling space 28 is sealed off against the pressure space 86, just as the gearbox input shaft 19 is sealed off against the drive-side housing hub 15, and as the clutch hub 40 is sealed off against first cover plate 34 of the torsional vibration damper 38 and against the support shaft 47. The purpose of the seals is to prevent a significant percentage of the fluid flow being conducted from channel 50 via the flow channels 96 into the cooling space 28 from escaping either via the torsional vibration damper 38 into the channel 49 or directly from the channel 50 into the channel 49 without first having reached the clutch elements 22 and 24 to cool them. In contrast, the seals between the gearbox input shaft 19 and the drive-side housing hub 15 prevent the fluid, which is supplied to build up the pressure in the pressure space 86 and which is conducted to this space via the control line 94 in the gearbox input shaft 19 and via the flow passages 90, 92, from escaping into the cooling space 28.

According to FIG. 1, the pressure-exerting device 80 is in its released position, in which the clutch elements 22, 24 are relieved of load and therefore are unable to transmit to the takeoff 18 any of the torque, originating from the drive 11 and arriving at the clutch elements via the housing 5. As a result of the buildup of a positive pressure in the pressure space 86 versus the cooling space 28, the pressure-exerting device 80 is shifted axially toward the clutch elements 22, 24 against the action of the axial force storage device 54 of the clutch-release support arrangement 52 and under deformation of the axial force storage device 57 of the torque-building arrangement 56. During the first part of this displacement of the pressure-exerting device 80 a point of contact is reached in which the torque-building arrangement 56 applies a weak pressure against the adjacent clutch element 22. However, in this area of contact the pressure is insufficient to bring the clutch elements 22, 24 into a working connection with each other for the transmission of torque. As the pressure in the pressure space 86 continues to build, the pressure-exerting device 80 is pressed more and more strongly against the adjacent clutch element 22 and via this element against the other clutch elements 22, 24. The clutch elements 22, 24 are pressed more and more strongly together, because any further movement of the clutch elements toward the takeoff-side housing wall 21 is prevented by the clutch element closest to the housing wall, namely, by the clutch element 22 which is permanently attached to the housing outer shell 23. As the force being exerted by the pressure-exerting device 80 on the clutch elements 22, 24 continues to increase, torque begins to be transmitted, and when the pressure-exerting device 80 has reached its fully engaged position and its shifting movement is stopped, the clutch elements 22, 24 are pressed against each other with an axial force which renders possible the transmission of the maximum amount of torque. The axial force storage device 57 of the torque-building arrangement 56 reaches its maximum applied force at a predetermined position of the pressure-exerting device 80, preferably in an axial range between the contact point and the engaged position, whereupon the pressure-exerting device 80, which must exert a much higher force, acts from that point on without the support of the torque-building arrangement 56.

Because of the elasticity introduced by the axial force storage device 57 of the torque-building arrangement 56, the pressure-exerting device 80, which is much less elastic than the torque-building arrangement 56, can be brought into working connection with the friction surfaces of the clutch elements 22, 24, which are also comparatively nonelastic, in a relatively soft and uniform manner. In addition, the torque-building arrangement 56 is also able to compensate for radial and/or axial tolerances between the clutch elements 22, 24 as well as for any waviness which may be present on their friction surfaces in the circumferential direction and thus to increase the degree of utilization of these friction surfaces for the transmission of torque while simultaneously reducing the pressures applied per unit surface area.

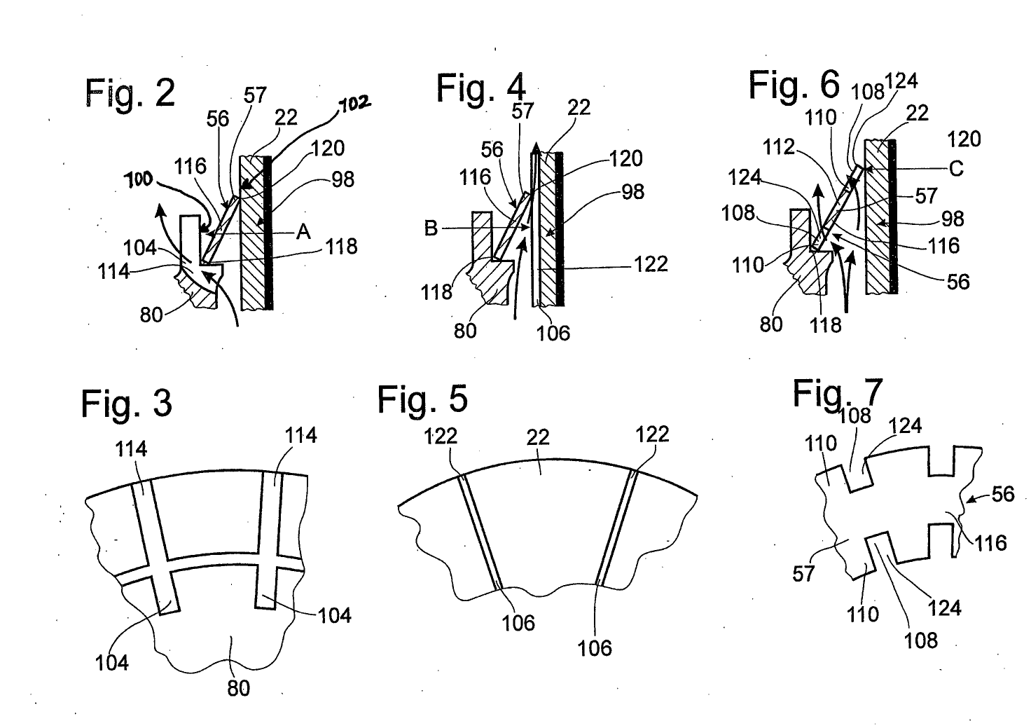

Preferably, the axial force storage device 57 of the torque-building arrangement 56 is designed as a disk spring 116, which, as shown in FIG. 2, rests on one side against a support area 118 of the pressure-exerting device 80, which serves as the first support element 100, and on the other side against a support area 120 of the adjacent clutch element 22, which serves as the second support element 102. Immediately adjacent to the first support area 118, grooves 114 are formed in the pressure-exerting device 80. As shown in FIG. 3, these grooves are provided at predetermined circumferential distances from each other and together serve as a flow channel 104. As a result of the rotational movement of the clutch elements 22, which are connected nonrotatably to the drive 11, relative to the clutch elements 24, which are connected nonrotatably to the takeoff 18, a flow is generated with the fluid present in the housing 5 of the clutch device 3. This flow is represented symbolically in FIG. 2 by arrows and passes through the grooves 114 of the pressure-exerting device 80. As a result, the pressure-exerting device 80 is cooled.

Whereas, as shown in FIG. 2, the flow channel 104 is associated with the first support area 118 of the torque-building arrangement 56, FIG. 4 shows how a flow channel 106 cooperates with the second support area 120. The flow channel 106 is formed by grooves 122, which, as shown in FIG. 5, are designed with a predetermined circumferential offset from each other. As shown in FIG. 4, these grooves are located in the side of the clutch element 22 which faces the torque-building arrangement 56. Here, too, the flow of the fluid in the cooling space 28 is represented symbolically by arrows, which show that, in this way, the clutch element 22 of the friction clutch 98 is subjected to a cooling action.

Of course, the embodiments shown in FIGS. 2-5 can be combined with each other in such a way that the support areas 118, 120 of the two support elements 100, 102 can be cooled simultaneously. As can be seen from the arrows symbolically representing the flow of the fluid in the cooling space 28, this is also possible in the case of the embodiment according to FIGS. 6 and 7, in which the torque-building arrangement 56 has a disk spring 116, serving as an axial force storage device 57. This disk spring has a central base body 112 and tongues 110, connected to the radially inner and outer sides of the base body. The tongues are arranged at predetermined circumferential distances from each other. Each pair of tongues forms an opening 124 (FIG. 7), and the sum of all these openings acts as the flow channel 108.

Of course, in the case of the disk spring 116 according to FIG. 6 or FIG. 7, it is possible, as an alternative to the embodiment described here, to provide tongues 110 on only one radial side—either the radially inner or outer side—to form the openings 124 and thus a flow channel 108. Corresponding to the choice of the previously mentioned radial side, therefore, it is also possible to cool only the pressure-exerting device 80 or only the clutch element 22 adjacent to it.

The invention is not limited by the embodiments described above which are presented as examples only but can be modified in various ways within the scope of protection defined by the appended patent claims.

We claim:

1. The clutch device having a housing connected to a drive; a takeoff which is rotatable relative to the housing; and at least one friction clutch which is mounted in the housing and which can be shifted between an engaged position and a released position, said clutch device comprising:
at least one pressure-exerting device (80) and at least one clutch element (22, 24) which can be actuated by said pressure-exerting device (80), both said clutch elements (22, 24) and said pressure-exerting device (80) being able to shift position to a limited extent in an axial direction; a torque-building arrangement (56) exerting a force on said pressure-exerting device (80) in the direction pointing away from said clutch element (22), said torque-building arrangement (56) using said pressure-exerting device (80) as a first support element (100) on one side and said clutch element (22) as second support element (102) on the other side; and at least one flow passage (104, 106, 108) provided in at least one of said support elements (100, 102) and said torque-building arrangement (56) for guiding a fluid present in a cooling space inside the clutch housing.

2. The clutch device according to claim 1, wherein said pressure-exerting device (80) has a support area (118) for said torque-building arrangement (56) and at least one set of grooves (114) serving as a flow passage (104) adjacent said support area (118).

3. The clutch device according to claim 1, wherein said clutch element (22) has a support area (120) for the torque-building arrangement (56) and at least one set of grooves (122) serving as a flow channel (106) adjacent said support area (120).

4. The clutch device according to claim 1, wherein said torque-building arrangement (56) has at least one opening (124) serving as a flow passage (108) on at least one of the side facing said pressure-exerting device (80) and on the side facing said clutch element (22), said openings being formed by adjacent tongues (110) of said torque-building arrangement (56).

5. The clutch device according to one of claims 1, wherein said torque-building arrangement (56) additionally comprises an axial force storage device (57).

6. The clutch device according to claim 5, wherein said axial force storage device (57) is formed as a disk spring (116) having an essentially ring-shaped base body (112).

7. The clutch device according to claims 6, additionally comprising at least two tongues (110) being circumferentially offset from each other and located adjacent at least one radial side of said base body (112) of said disk spring (116), each pair of said tongues defining the circumferential boundaries of an opening (124).
